(19) United States
(12) Patent Application Publication
(10) Pub. No.: US 2024/0220874 A1
(43) Pub. Date: Jul. 4, 2024

(54) METHOD AND APPARATUS FOR SCHEDULING ITINERARY USING ARTIFICIAL INTELLIGENCE

(71) Applicant: MYRO CO., LTD, Seoul (KR)

(72) Inventors: Joon Hyung CHO, Seoul (KR); Se Heon LEE, Gyeonggi-do (KR)

(21) Appl. No.: 17/919,163

(22) PCT Filed: Sep. 14, 2022
(86) PCT No.: PCT/KR2022/013695

§ 371 Date: Oct. 14, 2022

(51) Int. Cl. G06Q 10/02; G06Q 50/14

(52) U.S. Cl. CPC G06Q 10/025; G06Q 50/14

(57) ABSTRACT

The present specification relates to a method of generating, by a user, an itinerary of a user. The method includes receiving an itinerary request message from user equipment of the user, the itinerary request message including information of 1) a travel date of the user, 2) a travel time allocated for each travel date, 3) accommodation, and 4) travel places to be visited; generating the itinerary based on the itinerary request message; and transmitting the itinerary to the user equipment in response to the itinerary request message, in which the information of the travel place may include 1) a location and 2) an operating time of the travel place.

### TECHNICAL FIELD

The present specification relates to a method and apparatus for automatically scheduling an itinerary of a user using an artificial intelligence model.

### BACKGROUND

In general, in order to generate an itinerary, a traveler needs to individually schedule locations, business days, business hours, a travel time between places, etc., of accommodations and each place by date while checking a map.

If a traveler modifies an itinerary, the traveler needs to newly calculate a travel time between changing places and reflect the calculated travel time in the itinerary, and go through the cumbersome process of reconfirming and modifying business days, business hours, etc., of the changed places.

However, in the field of artificial intelligence, research on a method for solving this inconvenience has not been actively conducted.

### SUMMARY

The present specification provides a method and apparatus for automatically generating an itinerary by receiving a user's travel time, accommodations, and travel places for each travel date.

In addition, the present specification provides a method and apparatus for easily modifying, by a user, a generated itinerary.

Objects of the present specification are not limited to the above-mentioned objects. That is, other objects that are not mentioned may be obviously understood by those skilled in the art to which the present specification pertains from the following detailed description.

According to an aspect of the present invention, a method of generating, by a server, an itinerary of a user may include: receiving an itinerary request message from user equipment of the user, the itinerary request message including information of 1) a travel date of the user, 2) a travel time allocated for each travel date, 3) accommodation, and 4) travel places to be visited; generating the itinerary based on the itinerary request message; and transmitting the itinerary to the user equipment in response to the itinerary request message, in which the information of the travel place includes 1) a location and 2) an operating time of the travel place.

The generating of the itinerary may include: clustering the travel locations based on the number of travel dates; allocating clusters to the accommodation; and generating the itinerary based on the cluster.

In the clustering, a K-means clustering algorithm may be used, where K may be the number of travel dates.

The allocating of the clusters to the accommodation may include: calculating a sum of distance values to the plurality of accommodations for the travel places; and allocating a cluster including a travel place having a largest sum of distance values to accommodation closest to a travel place having the largest sum of distance values.

The generating of the itinerary may include reconfiguring the cluster based on 1) the operating time and 2) the travel date.

The generating of the itinerary may include re-clustering the cluster based on the plurality of travel dates being assigned to the same accommodation.

According to another aspect of the present invention, a server for generating an itinerary of a user may include: a memory; a communication unit; and a processor that functionally controls the memory and the communication unit, in which the processor may receive an itinerary request message from user equipment of the user using the communication unit, the itinerary request message including information of 1) a travel date of the user, 2) a travel time allocated for each travel date, 3) accommodation, and 4) travel places to be visited, generate the itinerary based on the itinerary request message, and transmit the itinerary to the user equipment in response to the itinerary request message, the information of the travel place including 1) a location and 2) an operating time of the travel place.

### BRIEF DESCRIPTION OF THE DRAWINGS

FIG. 1 is a block diagram for describing an electronic device according to the present specification.

FIG. 2 is a block diagram of an AI device according to an embodiment of the present specification.

FIG. 3 is an example of a travel scheduling system to which the present specification may be applied.

FIG. 4 is a diagram illustrating an embodiment to which the present specification may be applied.

FIG. 5 is an embodiment of a method of generating an itinerary of a server to which the present specification may be applied.

The accompanying drawings, which are included as part of the detailed description to assist understanding of the present disclosure, illustrate embodiments of the present disclosure and explain the technical features of the present disclosure together with the detailed description.

### DETAILED DESCRIPTION OF EMBODIMENTS

Hereinafter, embodiments of the present disclosure will be described in detail with reference to the accompanying drawings and the same or similar components are given the same reference numerals regardless of the numbers of figures and are not repeatedly described. In addition, terms “module” and “unit” for components used in the following description are used only to easily make the disclosure. Therefore, these terms do not have meanings or roles that distinguish from each other in themselves. Further, when it is decided that a detailed description for the known art related to the present disclosure may obscure the gist of the present disclosure, the detailed description will be omitted. Further, it should be understood that the accompanying drawings are provided only in order to allow exemplary embodiments of the present disclosure to be easily understood, and the spirit of the present disclosure is not limited by the accompanying drawings, but includes all the modifications, equivalents, and substitutions included in the spirit and the scope of the present disclosure.

Terms including ordinal numbers such as “first”, “second”, etc., may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween.

Singular forms are intended to include plural forms unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

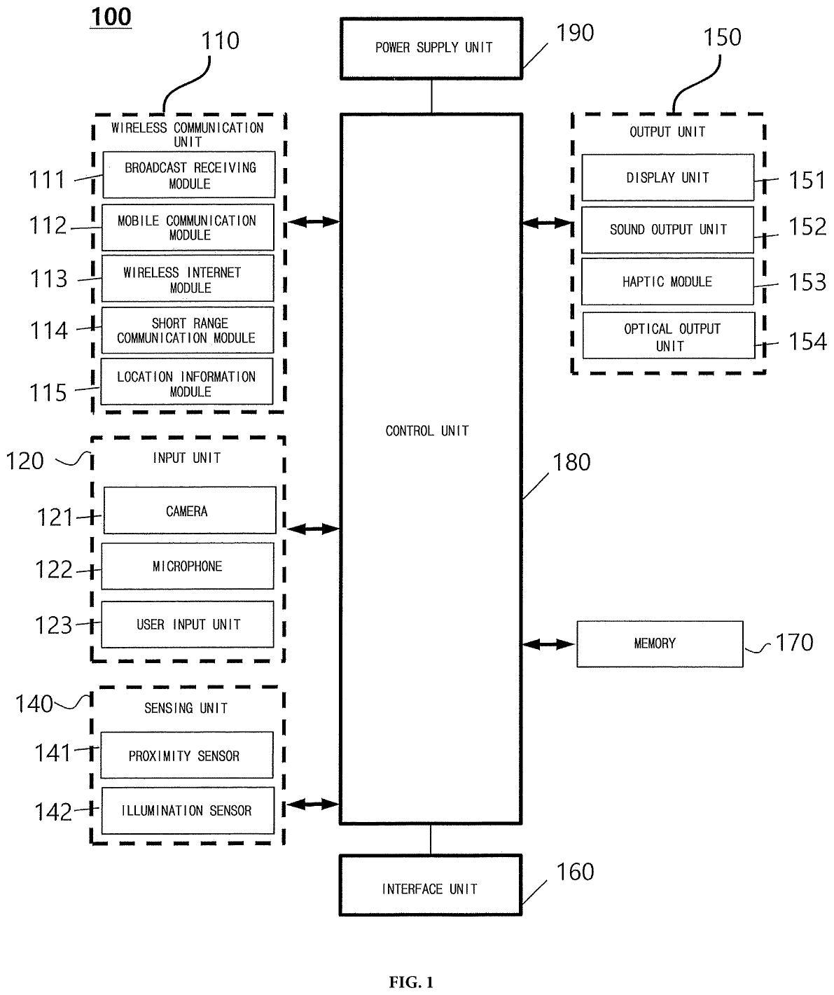

FIG. 1 is a block diagram for describing an electronic device according to the present specification.

An electronic device 100 includes a wireless communication unit 110, an input unit 120, a sensing unit 140, an output unit 150, an interface unit 160, a memory 170, a control unit 180, a power supply unit 190, and the like. The components illustrated in FIG. 1 are not essential to implementing electronic devices, so the electronic devices described herein may have more or fewer components than those listed above.

More specifically, the wireless communication unit 110 of the components may include one or more modules which enable wireless communication between the electronic device 100 and a wireless communication system, between the electronic device 100 and other electronic devices 100, or the electronic device 100 and an external server. In addition, the wireless communication unit 110 may include one or more modules which connect the electronic device 100 to one or more networks.

The wireless communication unit 110 may include at least one of a broadcast receiving module 111, a mobile communication module 112, a wireless Internet module 113, a short range communication module 114, and a location information module 115.

The input unit 120 may include a camera 121 or an image input unit for inputting an image signal, a microphone 122 for inputting a sound signal, an audio input unit, or a user input unit 123 (for example, a touch key, a push key, and the like) for receiving information from a user. Voice data or image data collected by the input unit 120 may be analyzed and processed as a control command of a user.

The sensing unit 140 may include one or more sensors for sensing at least one of information in the electronic device, surrounding environment information surrounding the electronic device, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared sensor (IR sensor), a fingerprint sensor, an ultrasonic sensor, an optical sensor (e.g., see a camera 121), a microphone (see 122), a battery gauge, an environmental sensor (e.g., a barometer, a hygrometer, a thermometer, a radiation detection sensor, a thermal detection sensor, a gas detection sensor, etc.), and a chemical sensor (e.g., an electronic nose, a healthcare sensor, a biometric sensor, etc.). Meanwhile, the electronic device disclosed in the present specification may use a combination of information sensed by at least two or more of these sensors.

The output unit 150 is used to generate an output related to sight, hearing, tactile sense, or the like, and may include at least one of a display unit 151, a sound output unit 152, a haptic module 153, and an optical output unit 154. The display unit 151 forms a layer structure with or is integrally formed with the touch sensor, thereby implementing a touch screen. The touch screen may function as the user input unit 123 which provides an input interface between the electronic device 100 and the user, and may provide an output interface between the electronic device 100 and the user.

The interface unit 160 serves as a path of various types of external devices connected to the electronic device 100. The interface unit 160 may include at least one of a wired/wireless headset port, an external charger port, a wired/wireless data port, a memory card port, a port for connection of a device including an identity module, an audio input/output (I/O) port, a video input/output (I/O) port, and an earphone port. In the electronic device 100, an appropriate control related to the connected external device may be performed in response to the connection of the external device to the interface unit 160.

In addition, the memory 170 stores data supporting various functions of the electronic device 100. The memory 170 may store a plurality of application programs or applications that are driven by the electronic device 100, and data and instructions for operating the electronic device 100. At least some of these application programs may be downloaded from the external server via the wireless communication. In addition, at least some of these application programs may exist on the electronic device 100 from the time of shipment for basic functions (for example, an incoming and outgoing call function, and a message reception and transmission function) of the electronic device 100. Meanwhile, the application program may be stored in the memory 170, installed on the electronic device 100, and driven by the control unit 180 to perform the operation (or function) of the electronic device.

In addition to the operation related to the application program, the control unit 180 typically controls the overall operation of the electronic device 100. The control unit 180 may provide or process appropriate information or a function to a user by processing signals, data, information, and the like, which are input or output through the above-described components, or by driving an application program stored in the memory 170.

In addition, the control unit 180 may control at least some of the components described with reference to FIG. 1 to drive the application program stored in the memory 170. In addition, the control unit 180 may operate at least two or more of the components included in the electronic device 100 in combination with each other to drive the application program.

The power supply unit 190 receives power from an external power source and an internal power source under the control of the control unit 180 and supplies the received power to each component included in the electronic device 100. The power supply unit 190 includes a battery which may be a built-in battery or a replaceable battery.

At least some of the components may operate in cooperation with each other in order to implement an operation, a control, or a control method of the electronic device according to various embodiments described below. In addition, the operation, control, or control method of the electronic device may be implemented on the electronic device by driving at least one application program stored in the memory 170.

In the present specification, the electronic device 100 may be collectively referred to as user equipment and/or a server.

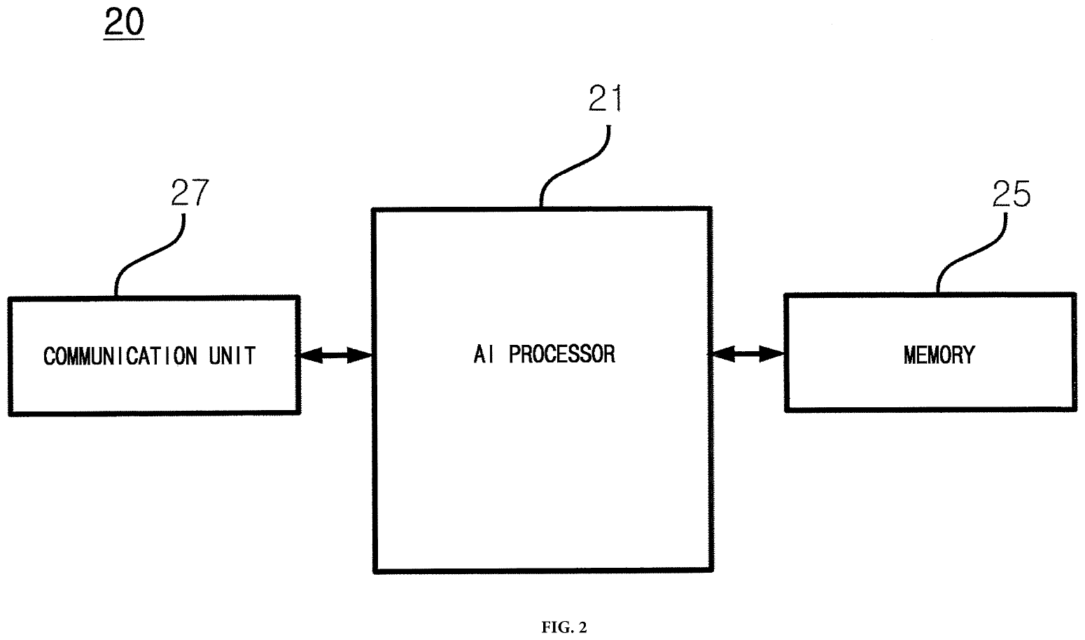

FIG. 2 is a block diagram of an AI device according to an embodiment of the present specification.

The AI device 20 may include an electronic device including an AI module capable of performing AI processing, a server including the AI module, or the like. In addition, the AI device 20 may be included in at least a part of the electronic device 100 illustrated in FIG. 1 and may be provided to perform at least a part of the AI processing together.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, and a tablet PC.

The AI processor 21 may train a neural network using a program stored in the memory 25. In particular, the AI processor 21 may train a neural network to schedule a user's itinerary.

Meanwhile, the AI processor 21 performing the functions as described above may be a general purpose processor (for example, CPU), but may be an AI dedicated processor (for example, GPU) for artificial intelligence learning.

The memory 25 may store various programs and data required for an operation of the AI device 20. The memory 25 may be implemented by a non-volatile memory, a volatile memory, a flash memory, a hard disc drive (HDD), a solid state drive (SSD), or the like. The memory 25 is accessed by the AI processor 21, and readout/recording/correction/deletion/update, and the like, of data in the memory 25 may be performed by the AI processor 21. In addition, the memory 25 may store a neural network model (e.g., a deep learning model) generated through a learning algorithm for data classification/recognition according to an embodiment of the present specification.

Meanwhile, the AI processor 21 may include a data learning unit which learns a neural network for data classification/recognition. For example, the data learning unit acquires learning data to be used for learning, and applies the obtained learning data to the deep learning model, thereby making it possible to train the deep learning model.

The communication unit 27 may transmit the AI processing result by the AI processor 21 to an external electronic device.

Here, the external electronic device may include another user equipment (UE) and a server.

Meanwhile, the AI device 20 illustrated in FIG. 2 has been described functionally divided into the AI processor 21, the memory 25, the communication unit 27, and the like. However, the above-described components are integrated into one module, which may be referred to as an AI module.

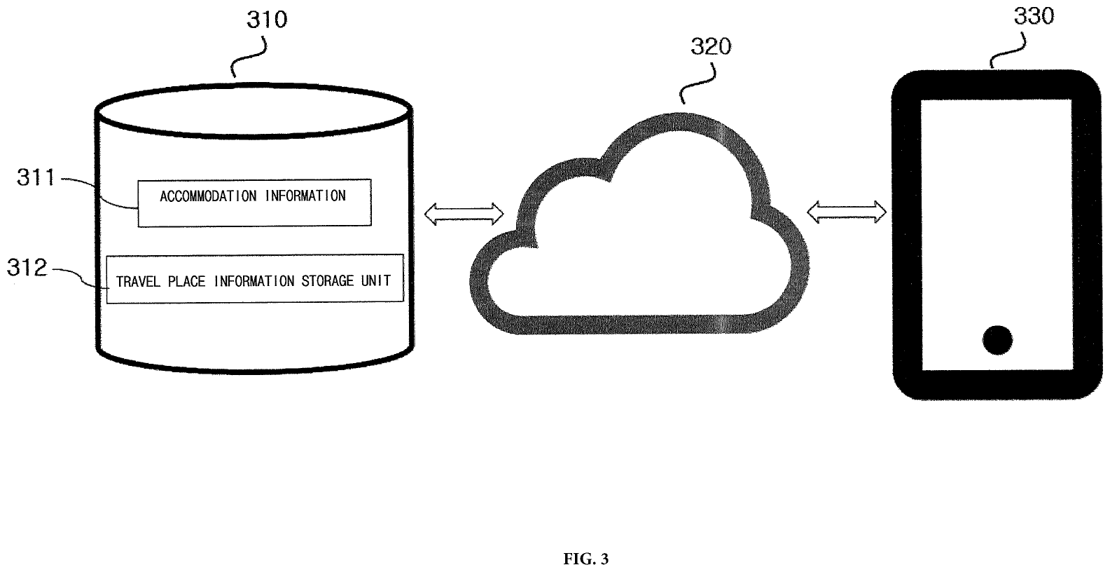

FIG. 3 is an example of a travel scheduling system to which the present specification may be applied.

A travel scheduling system provided in the present specification includes a database 310 for providing information of accommodation and/or travel place, a server 320 for providing a travel scheduling service, and user equipment 330.

The database 310 includes an accommodation information storage unit 311 for storing and managing accommodation information, and a travel place information storage unit 312 for storing and managing travel place information. The accommodation information may include information such as a name, a type, a location, an operating time, and usage cost of the accommodation. The travel place information may include a name, a type (e.g., museum, accommodation, amusement park, restaurant, church, etc.), a location (e.g., latitude and longitude), an address, an operating time (e.g., business hours, business days), usage costs, etc., of the travel place. In addition, the server 320 and/or the database 310 may generate or manage personalized information (e.g., satisfaction level and recommended usage time) for each user of the accommodation and the travel place, or a time staying at the travel place.

The database 310 may be operated/managed by the same subject or a separate entity as a service providing the corresponding travel scheduling. For example, the server 320 may be connected to the database 310 operated by Google, Naver, etc., and receive the public accommodation information and travel place information. The server 320 may be operated in the form of a cloud server, and may be connected to the database 310 and the user equipment 330 to transmit/receive data.

The UE 330 may be connected to the server 320 through a preloaded program or a separate program for the corresponding travel scheduling service to transmit/receive data for the travel scheduling service, and provide the transmitted/received data to a user.

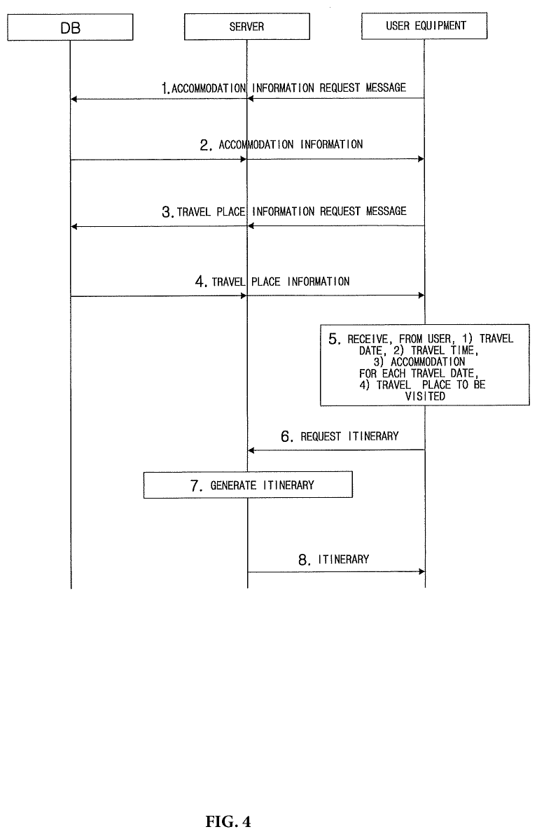

FIG. 4 is a diagram illustrating an embodiment to which the present specification may be applied.

The travel scheduling system proposed in the present specification may receive only travel date, accommodation information by date, and travel place information to be visited from the user, in order to generate a detailed itinerary plan by date of the user, and automatically generate detailed schedules by date and minute. In addition, a user may simply customize the provided itinerary.

Referring to FIG. 4, the UE may start a service for travel scheduling through a loaded program.

1. The UE transmits the accommodation information request message to the database. For example, the UE may request accommodation information of accommodations included in a list preset in the UE from the server through the accommodation information request message. Alternatively, the UE may request the accommodation information of the accommodation requested by a user to search from the server through the accommodation information request message. The server transmits the accommodation information request message to the database in response to the accommodation information request message received from the UE. For example, the server may request, from the database, not only the accommodation information requested from the UE, but also the accommodation information of the accommodation similar to the accommodation requested by the UE.

2. The database transmits the accommodation information to the UE in response to the accommodation information request message. For example, the accommodation information may include the accommodation information of the accommodation requested by the server. The server may add UE user's personalized information to the accommodation information received from the database and transmit the added UE user's personalized information to the UE.

3. The UE transmits the travel place information request message to the database. For example, the UE may request the travel place information of the travel place included in the list preset in the UE from the server through the travel place information request message. Alternatively, the UE may request the travel place information of the travel place requested by the user to the server through the travel place information request message. The server transmits the travel place information request message to the database in response to the accommodation information request message received from the UE. For example, the server may request, from the database, not only the travel place information requested from the UE, but also the travel place information of a travel place similar to the travel place requested by the UE.

4. The database transmits the travel information to the UE in response to the travel place information request message. For example, the travel place information may include the travel place information of the travel place requested by the server. The server may add the UE user's personalized information to the travel place information received from the database and transmit the added UE user's personalized information to the UE. In addition, the server may transmit information about time staying at the travel place to the UE together. For example, the server may set the information about time staying at the travel place to an appropriate time according to the type of the travel place. In more detail, the information about time staying at the travel place may be set, as a default value, to 8 hours for an amusement park, 3 hours for a museum, 3 hours for an art gallery, and 2 hours for a restaurant.

5. The UE receives 1) travel date, 2) travel time, 3) accommodation for each travel date, and/or 4) travel place to be visited from a user. For example, the UE may provide the user with the accommodation information and travel place information (travel place information may include the information on time staying at a travel place) received from the server. The UE may receive a travel date, a travel time for each travel date (e.g., travel start time and/or end time for each travel date), accommodation, a travel place to be visited, and/or information on the time a user wants to stay for each travel place from the user through the input unit 120. When the accommodation information is not received from the user, the UE may include an indicator informing that the server may arbitrarily select the accommodation information. In this case, the server may select accommodation by using the accommodation information storage unit 311. For example, the server may arbitrarily select accommodation that users are most satisfied with.

When the information on the time the user wants to stay for each travel place is not received from the user, the UE may include a default value in the time information.

Table 1 is an example of data received from a user. Referring to Table 1, when a user plans to travel in Paris for six days and five nights, the UE may receive the following data from the user.

TABLE 1

| Name | Data |
|---|---|
| Travel date | 2021 Oct. 1-2021 Oct. 6 |
| Travel time | 2021 Oct. 1(14:00-21:00), |
| | 2021 Oct. 1-2021 Oct. 5(10:00-22:00), |
| | 2021 Oct. 6(09:00-16:00) |
| Accommodation | 2021 Oct. 1-2021 Oct. 3(Hotel A), |
| | 2021 Oct. 3-2021 Oct. 5(Hotel B), |
| | 2021 Oct. 5-2021 Oct. 6(Hotel A) |
| Travel | Eiffel Tower, Louvre Museum, Champs Elysees, |
| place | Arc de Triomphe, Versailles, Notre Dame, Orsay |
| | Museum, Tullch Garden, Sacre Coeur Cathedral, |
| | Montmartre Hill, Orangerie Museum, Restaurant |
| | A, Restaurant B, Restaurant C, Restaurant D, |
| | Restaurant E, Restaurant F |
| Time | Include information on time user wants to stay |
| information | for each travel place, or default value |
| for each | |
| travel place | |

6. The UE receives the itinerary request message from the server. For example, the itinerary request message may include a user's travel date, a travel time for each travel date (e.g., travel start time and/or end time for each travel date), accommodation, a travel place to be visited, and/or the information on the time the user wants to stay for each travel place that are received by the UE from the user.

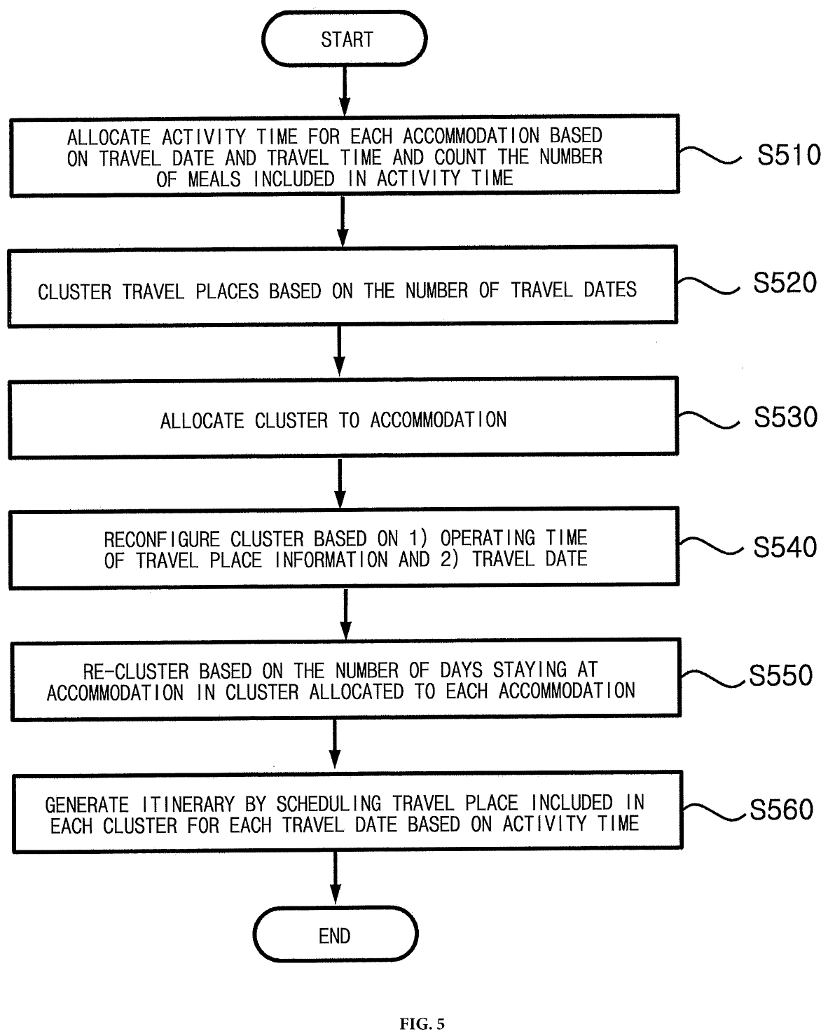

7. The server generates the user's itinerary in response to the UE's itinerary request message. A specific method related to the server's itinerary generation will be described later with reference to FIG. 5.

8. The server transmits the generated user's itinerary to the UE. The UE may indicate the received itinerary to the user.

FIG. 5 is an embodiment of a method of generating an itinerary of a server to which the present specification may be applied.

Referring to FIG. 5, while receiving the itinerary request from the UE, the server may receive the user's travel date, travel time for each travel date, accommodation, and/or travel place to be visited together.

The server allocates an activity time for each accommodation based on the travel date and travel time, and counts the number of meals included in the activity time (S510). For example, when the travel time is from 10 am to 10 pm on January 1, and the accommodation is Hotel A, the server may allocate 12 hours to Hotel A as an activity time, and count the number of meals including lunch/dinner as 2.

The server clusters travel places based on the number of travel dates using an artificial intelligence model (S520). For example, the server may cluster travel places using a K-means clustering algorithm. The k-means clustering algorithm is an algorithm that clusters given data into k clusters, and may operate in a way that minimizes a variance of a difference between each cluster and distance. The K-means clustering algorithm of the present specification may be a known standard algorithm, and the input value “K” may be the number of travel dates.

The server allocates the cluster to the accommodation (S530). In more detail, the server may calculate the sum of distance values to locations of all accommodations for all travel places. For example, the sum (18 KM) of distance values to all accommodations A (e.g., 5 KM), B (e.g., 3 KM), and C (e.g., 10 KM) for travel place “A” may be calculated.

The server may allocate a cluster including a travel place having a largest sum of distance values to accommodation closest to the travel place. For example, when 18 KM is larger than other travel places, the server may allocate a cluster including “A” to B which is the closest accommodation. Thereafter, for the travel places included in the remaining cluster, the server may select a travel place having the largest sum of distance values again, and allocate all the clusters to accommodation by repeating the operation of allocating the cluster including the travel place to other accommodations closest to the travel place When a plurality of same accommodations selected by a user exist for each travel date, such accommodations may be allocated a plurality of clusters for each travel date. When all the accommodations are different, each of the accommodations may be allocated different clusters.

The server reconfigures the cluster based on 1) the operating time of travel place information and 2) the travel date (S540). In more detail, based on the operating time of the travel place information, when the travel place is not available on the travel date of the allocated accommodation, the server may move the travel place to the cluster allocated to the closest accommodation on the travel date where the travel place is available, in addition to the allocated accommodation. For example, when “A” is closed on Monday and the travel date of B which is allocated the cluster containing “A”, is Monday, the server may move “A” to the cluster allocated to the next closest accommodation C.

The server clusters the travel places of the cluster allocated for each accommodation again based on the number of days staying in the corresponding accommodation (S550). For example, when C's travel date was three days, C is allocated three clusters. The server clusters the travel places included in the three clusters again using the k-means clustering algorithm. In this case, K may be 3. As a result, the distribution of the travel places included in each cluster may be made wider.

The server generates an itinerary by scheduling travel places included in each cluster for each travel date based on the activity time (S560). For example, the server may first consider an operating time of travel places. In more detail, the server may calculate an optimal route to visit the travel places in the cluster allocated to the accommodation from the accommodation based on the activity time so that a user may use the travel places within the operating time. In addition, when the number of travel places classified as a restaurant is smaller than the counted number of meals, the server may schedule travel places so that a user may use a restaurant at breakfast/lunch/dinner time. When there are more restaurants than the number of meals, the server may consider that the user intends to go on a restaurant trip and ignore a meal time. As a result, the server may provide an optimized itinerary to a user.

The present specification described above can be embodied as a computer readable code on a medium in which a program is recorded. A computer readable medium may include all kinds of recording devices in which data that may be read by a computer system are stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, and the like, and also include a medium implemented in a form of a carrier wave (for example, transmission through the Internet). Therefore, the above-mentioned detailed description is to be interpreted as being illustrative rather than being restrictive in all aspects. The scope of the present specification is to be determined by reasonable interpretation of the claims, and all modifications within an equivalent range of the present specification fall in the scope of the present specification.

According to the present specification, it is possible to provide a method and apparatus for automatically generating an itinerary by receiving a user's travel time, accommodation, and travel places for each travel date.

In addition, according to the present specification, it is possible to provide a method and apparatus for easily modifying, by a user, a generated itinerary.

Effects which can be achieved by the present specification are not limited to the above-mentioned effects. That is, other objects that are not mentioned may be obviously understood by those skilled in the art to which the present specification pertains from the following description.

In addition, although the services and embodiments have been mainly described hereinabove, this is only an example and does not limit the present specification. Those skilled in the art to which the present specification pertains may understand that several modifications and applications that are not described in the present specification may be made without departing from the spirit of the present disclosure. For example, each component described in detail in an exemplary embodiment of the present invention may be modified. In addition, differences associated with these modifications and applications are to be interpreted as being included in the scope of the present specification as defined by the following claims.

What is claimed is:

1. A method of generating, by a server, an itinerary of a user, comprising:
receiving an itinerary request message from user equipment of the user, the itinerary request message including information of 1) a travel date of the user, 2) a travel time allocated for each travel date, 3) accommodation, and 4) travel places to be visited;
generating the itinerary based on the itinerary request message; and
transmitting the itinerary to the user equipment in response to the itinerary request message,
wherein the information of the travel place includes 1) a location and 2) an operating time of the travel place.

2. The method of claim 1, wherein the generating of the itinerary includes:
clustering the travel locations based on the number of travel dates;
allocating clusters to the accommodation; and
generating the itinerary based on the cluster.

3. The method of claim 2, wherein, in the clustering, a K-means clustering algorithm is used, where K is the number of travel dates.

4. The method of claim 2, wherein the allocating of the clusters to the accommodation includes:
calculating a sum of distance values to the plurality of accommodations for the travel places; and
allocating a cluster including a travel place having a largest sum of distance values to accommodation closest to a travel place having the largest sum of distance values.

5. The method of claim 2, wherein the generating of the itinerary includes reconfiguring the cluster based on 1) the operating time and 2) the travel date.

6. The method of claim 5, wherein the generating of the itinerary includes re-clustering the cluster based on the plurality of travel dates being assigned to the same accommodation.

7. A server for generating an itinerary of a user, comprising:
a memory;
a communication unit; and
a processor that functionally controls the memory and the communication unit,
wherein the processor receives an itinerary request message from user equipment of the user using the communication unit, the itinerary request message including information of 1) a travel date of the user, 2) a travel time allocated for each travel date, 3) accommodation, and 4) travel places to be visited, generates the itinerary based on the itinerary request message, and transmits the itinerary to the user equipment in response to the itinerary request message, the information of the travel place including 1) a location and 2) an operating time of the travel place.
